(19) United States
(12) Patent Application Publication
(10) Pub. No.: US 2014/0033143 A1
(43) Pub. Date: Jan. 30, 2014

(54) MANUFACTURING METHOD OF SEMICONDUCTOR MEMORY DEVICE

(71) Applicant: SAMSUNG ELECTRONICS CO., LTD., Suwon-si (KR)

(72) Inventor: Kihyun Kim, Anyang-si (KR)

(73) Assignee: Samsung Electronics Co., Ltd., Suwon-si (KR)

(21) Appl. No.: 13/861,720

(22) Filed: Apr. 12, 2013

(30) Foreign Application Priority Data
Jul. 30, 2012 (KR) 10-2012-0083382

(51) Int. Cl. G06F 17/50

(52) U.S. Cl. CPC G06F 17/50
USPC 716/53

(57) ABSTRACT

A method of manufacturing a semiconductor device is provided which includes forming a target layout; producing a skewed layout that includes retargeting the target layout; detecting an envelope of the skewed layout; generating a jog-free layout according to the detected envelope; fragmenting the jog-free layout; acquiring a layout that converges towards the skewed layout by performing an optical proximity correction on the fragmented jog-free layout; and patterning a material for forming the semiconductor device using the acquired layout.

### CROSS-REFERENCE TO RELATED APPLICATIONS

A claim for priority under 35 U.S.C. §119 is made to Korean Patent Application No. 10-2012-0083382 filed Jul. 30, 2012, in the Korean Intellectual Property Office, the entire contents of which are hereby incorporated by reference.

### BACKGROUND

The inventive concepts described herein relate to a manufacturing method of a semiconductor device, and more particularly, to a semiconductor device manufacturing method of patterning that includes performing optical proximity correction (OPC).

A semiconductor device may be manufactured by depositing various materials on a semiconductor substrate and etching the deposited materials. An etching process may include performing dry etching of the materials using plasma and wet etching using chemicals. A dry etching process may include forming a photoresist mask on a target material, then radiating plasma on the mask. A portion of the target material blocked by the mask may not be etched, while an exposed portion may be etched. When plasma passes through the exposed portion, plasma diffraction or reflection may arise, resulting in a skewed pattern.

### SUMMARY

One aspect of embodiments of the inventive concept is directed to provide a semiconductor device manufacturing method which includes forming a target layout; producing a skewed layout that includes retargeting the target layout; detecting an envelope of the skewed layout; generating a jog-free layout according to the detected envelope; fragmenting the jog-free layout; acquiring a layout that converges towards the skewed layout by performing an optical proximity correction on the fragmented jog-free layout; and patterning a material for forming the semiconductor device using the acquired layout.

In example embodiments, the envelope is a polygon which includes the skewed layout and excludes jogs.

In example embodiments, the jog comprises a surface having a length less than a reference value.

In example embodiments, the reference value is determined according to a design rule of the semiconductor device.

In example embodiments, the envelope is a quadrangle including the skewed layout.

In example embodiments, the acquiring the layout converging towards the skewed layout comprises: performing an iterative operation, in which fragments of the fragmented jog-free layout are independently adjusted and a patterning simulation is performed using the adjusted fragmented jog-free layout until a simulation result converging towards the skewed layout is acquired.

In example embodiments, patterning the material for forming the semiconductor device using the acquired layout comprises patterning holes to form the semiconductor device.

In example embodiments, patterning the material for forming the semiconductor device using the acquired layout comprises patterning lines to form the semiconductor device.

In example embodiments, the target layout has at least one jog.

Another aspect of embodiments of the inventive concept is directed to provide a semiconductor device manufacturing device which comprises a layout calculating unit that generates a final layout according to a target layout; and a patterning unit that patterns semiconductor materials according to the final layout transferred from the layout calculating unit. The layout calculating unit generates the final layout by producing a skewed layout from the target layout in view of a skew, generates a jog-free layout based on an envelope of the skewed layout, and fragments the jog-free layout for performing an optical proximity correction.

In example embodiments, the patterning unit patterns holes to form a semiconductor device from the semiconductor material.

In example embodiments, the patterning unit patterns lines to form a semiconductor device from the semiconductor material.

In example embodiments, the layout calculating unit performs an iterative operation, in which the fragments are independently adjusted and a patterning simulation is performed using the adjusted fragmented jog-free layout until a simulation result converging towards the skewed layout is acquired.

Another aspect of embodiments of the inventive concept is directed to method of manufacturing a semiconductor device comprising: generating a final layout according to a target layout, comprising: producing a skewed layout from the target layout in view of a skew; generating a jog-free layout based on an envelope of the skewed layout; fragmenting the jog-free layout; and performing an optical proximity correction on the fragmented jog-free layout; and patterning semiconductor materials according to the final layout.

In example embodiments, the envelope is a polygon which includes the skewed layout and excludes jogs.

In example embodiments, the envelope is a quadrangle including the skewed layout.

In example embodiments, the method further comprises acquiring a layout that converges towards the skewed layout by performing the optical proximity correction on the fragmented jog-free layout.

In example embodiments, acquiring the layout converging towards the skewed layout comprises: performing an iterative operation, in which fragments of the fragmented jog-free layout are independently adjusted and a patterning simulation is performed using the adjusted fragmented jog-free layout until a simulation result converging towards the skewed layout is acquired.

In example embodiments, wherein patterning the semiconductor materials comprises patterning holes to form the semiconductor device.

In example embodiments, patterning the semiconductor materials comprises patterning lines to form the semiconductor device.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a flow chart illustrating a semiconductor device manufacturing method according to an embodiment of the inventive concept.

FIG. 2 is a diagram illustrating a target layout according to an embodiment of the inventive concept.

FIG. 3 is a diagram illustrating a skewed layout obtained by retargeting a target layout according to an embodiment of the inventive concept.

FIG. 4 is a diagram illustrating a fragmentation of a layout according to an embodiment of the inventive concept.

FIG. 5 is a diagram illustrating optical proximity correction executed on the basis of fragments of FIG. 4.

FIG. 6 is a diagram illustrating a fragmentation executed on the basis of an envelope of a skewed layout according to an embodiment of the inventive concept.

FIG. 7 is a diagram illustrating an optical proximity correction (OPC) executed on the basis of fragments of FIG. 6.

FIG. 8 is a diagram illustrating a jog-free layout produced according to an envelope of a skewed layout of FIG. 3.

FIG. 9 is a diagram illustrating a target layout according to another embodiment of the inventive concept.

FIG. 10 is a diagram illustrating a skewed layout obtained by retargeting a target layout of FIG. 9.

FIG. 11 is a diagram illustrating a jog-free layout produced according to an envelope of a skewed layout of FIG. 10.

FIG. 12 is a diagram illustrating a target layout according to another embodiment of the inventive concept.

FIG. 13 is a diagram illustrating a skewed layout obtained by retargeting a target layout of FIG. 12.

FIG. 14 is a diagram illustrating a jog-free layout produced using an envelope of a skewed layout of FIG. 13.

FIG. 15 is a block diagram schematically illustrating a semiconductor device manufacturing system according to an embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

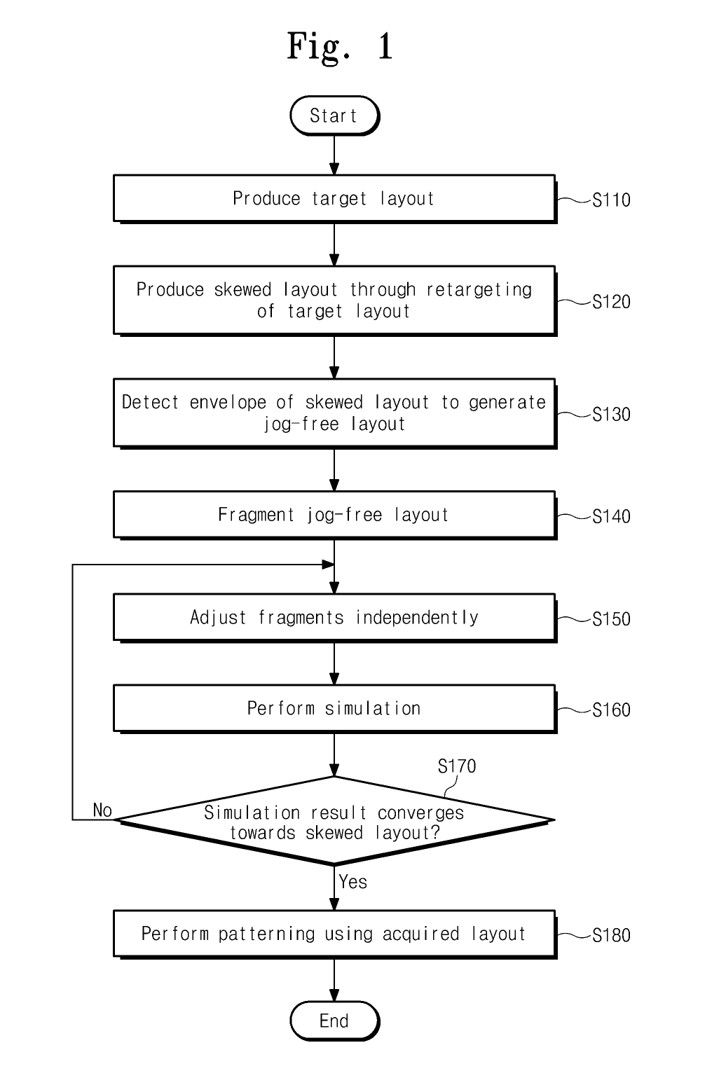

FIG. 1 is a flow chart illustrating a semiconductor device manufacturing method according to an embodiment of the inventive concept. In step S110, a target layout may be produced. The target layout relates to a target shape of a material that forms a semiconductor device. For example, in cases where a specific material forming a semiconductor device is etched to have a specific shape, the shape corresponds to the target layout.

In step S120, a skewed layout may be produced by retargeting the target layout. Here, the target layout can be adjusted that reflects etching skews or the like. When etching is performed, an etching characteristic may vary according to a distance between adjacent layouts. For example, when a distance between adjacent layouts increases, an etching area may be extended into an inside of a layout. That is, an etching skew may occur. The retargeting may be performed in view of a predictable etching skew. The retargeting may produce a skewed layout. This may occur by extending a layout of a portion of the target layout where the etching skew is predicted.

In step S130, a jog-free layout may be produced by detecting an envelope of the skewed layout. A jog may include a surface having a length less than a reference value, and may include a portion of the layout that is excluded from a correction target, for example, with respect to an optical proximity correction (OPC). A reference value used to determine a jog may be determined according to a design rule used to manufacture a semiconductor device.

The envelope may be constructed in the shape a polygon which includes the skewed layout but does not include a jog, as with the skewed layout of step S120. The polygon-shaped envelope may have a minimum area, which includes the skewed layout but does not include a jog. The envelope may be constructed in the shape of a quadrangle which includes the skewed layout and does not include a jog. The quadrangle-shaped envelope may be a minimum area quadrangle, which includes the skewed layout but does not include a jog. The envelope may include an area which is made by an extents command of a mentor caliber tool.

In operation S140, the jog-free layout may be fragmented. For example, the jog-free layout may be partitioned into a plurality of fragments by a predetermined unit. The dimensions or other configuration parameters related to a unit for fragmentation may be determined according to a design rule applied in the manufacturing of a semiconductor device.

In step S150, the fragments of the jog-free layout may be adjusted independently. For example, sizes of the fragments of the jog-free layout may be adjusted independently. In an embodiment, optical proximity correction (OPC) is performed on the fragmented jog-free layout.

In step S160, a simulation may be performed using the adjusted layout. In step S170, a determination is made whether the simulation result converges towards the skewed layout. Steps S150 to S170 may be repeated until the simulation result converges at or near the skewed layout.

In step S180, patterning may be performed using the acquired layout. For example, a material for forming a semiconductor device may be patterned using a layout where the simulation result converges at or near the skewed layout.

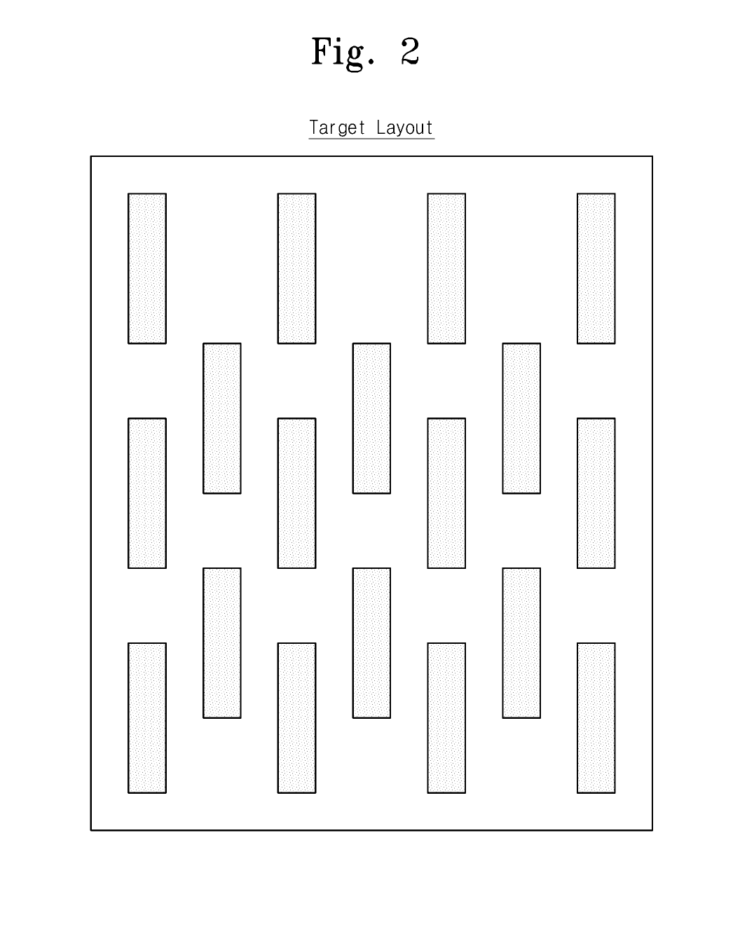

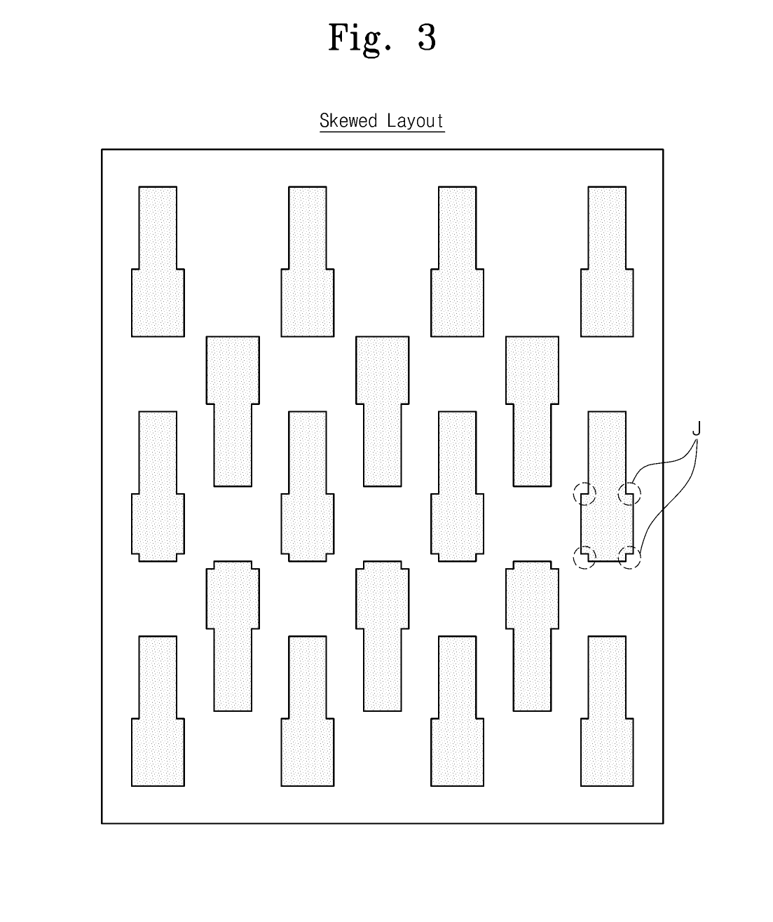

FIG. 2 is a diagram illustrating a target layout according to an embodiment of the inventive concept. FIG. 3 is a diagram illustrating a skewed layout obtained by retargeting a target layout, for example, by performing one or more steps of the method of claim 1. Referring to FIGS. 2 and 3, layouts for compensating for etching skew may be extended according to a distance between adjacent layouts, respectively. If retargeting is performed, jogs J may be generated at the layouts.

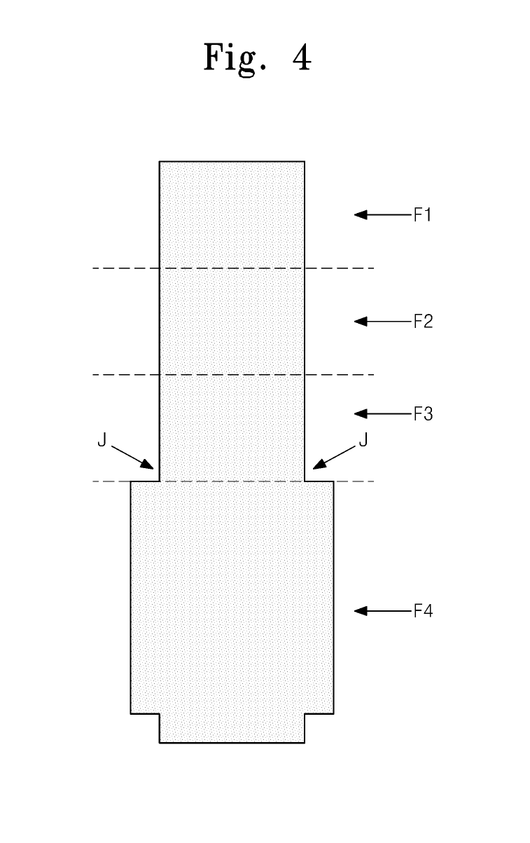

FIG. 4 is a diagram illustrating fragmentation of a layout. Referring to FIG. 4, fragments F1 to F4 may be formed on the basis of jogs J.

The fragments F1 to F4 may be formed to have a predetermined size. The predetermined size may be decided according to a design rule which is used to manufacture a semiconductor device. If fragments F 1 to F4 are formed on the basis of jogs J, a fragment may be formed having a size that is different from the predetermined size, for example, fragment F4. Here, fragment F4 may have a size which is too large to form a fragment and too small to form two fragments. If a fragment has an abnormal or insufficient size, the probability of a layout converging towards a skewed layout at an optical proximity correction (OPC) is acquired may be reduced.

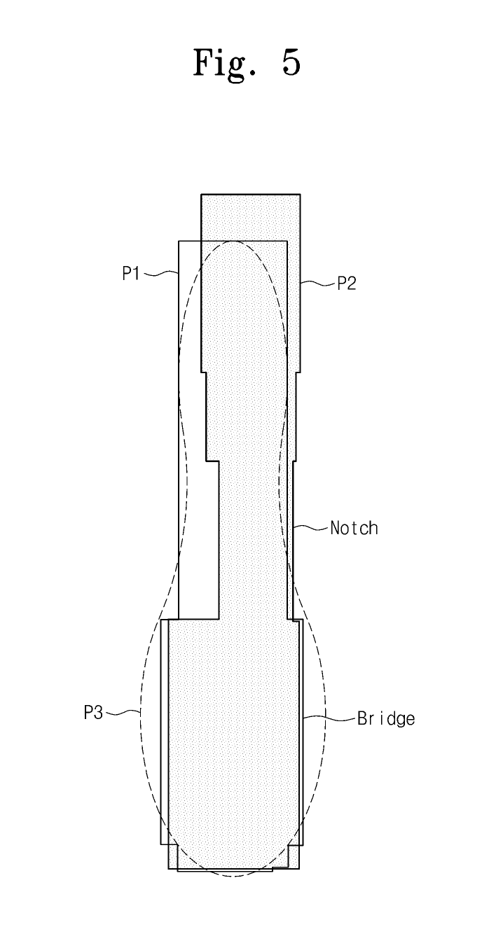

FIG. 5 is a diagram illustrating an optical proximity correction executed on the basis of fragments of FIG. 4. Referring to FIG. 5, reference symbol P1 refers to a skewed layout, and reference symbol P2 refers to a result of an optical proximity correction (OPC).

If an optical proximity correction (OPC) is performed using the skewed layout P1 including a jog, the probability that a notch having a width narrower than a normal pattern or a bridge having a width wider than the normal pattern is generated may increase. The notch may cause a cut-off. The bridge may cause a connection with an adjacent pattern. If optical proximity correction (OPC) is performed using the skewed layout P1 including a jog, the probability that a simulation result P3 converges towards the skewed layout P1 may decrease, so that a time required increases.

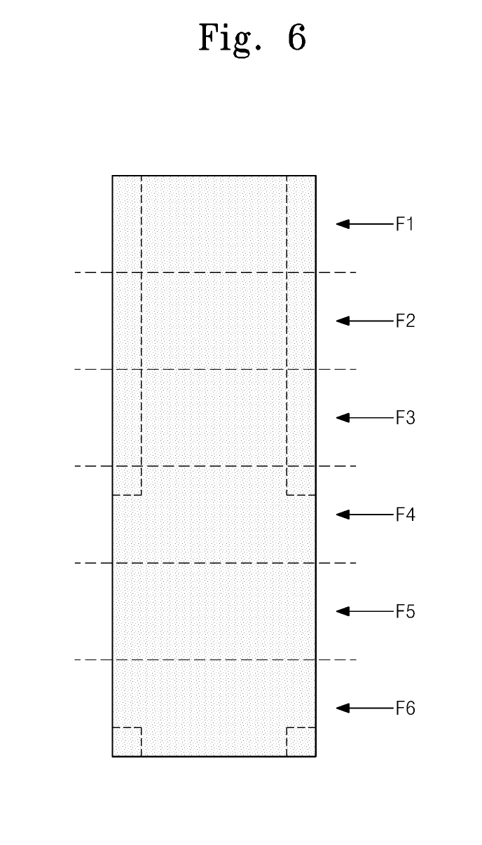

FIG. 6 is a diagram illustrating fragmentation executed on the basis of an envelope of a skewed layout, in accordance with an embodiment. Referring to FIG. 6, an envelope may be formed to include a skewed layout without including a jog. The envelope may be constructed and arranged in the shape of a polygon (e.g., a minimum area polygon) which includes a skewed layout and does not have a jog. Alternatively, the envelope may be constructed and arranged in the shape of a quadrangle (e.g., a minimum area quadrangle) which includes the skewed layout and does not have a jog. A jog-free layout may be produced based on the envelope, and fragmentation may be performed at the jog-free layout.

The jog-free layout may not have a jog excluded from an OPC target. Thus, the jog-free layout may be partitioned into fragments F1 to F6 according to a predetermined configuration.

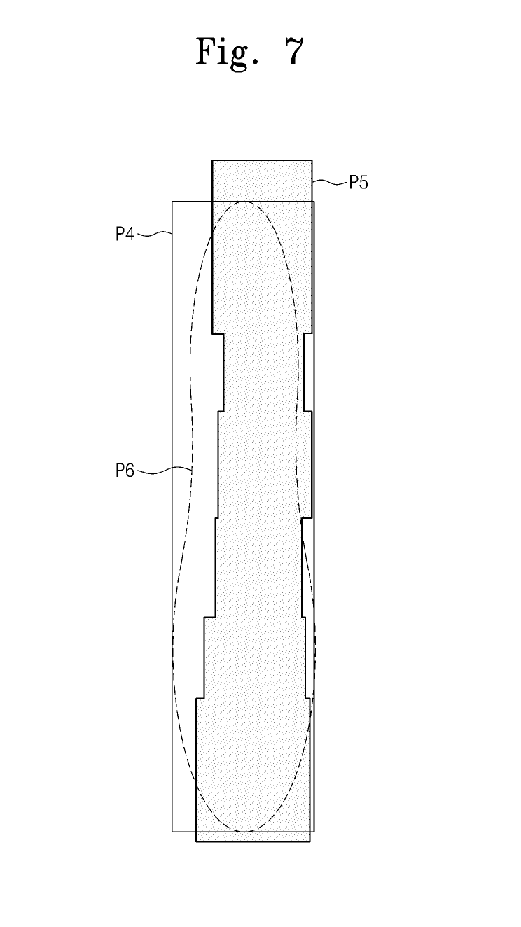

FIG. 7 is a diagram illustrating optical proximity correction (OPC) executed according to the fragments of FIG. 6. Referring to FIG. 7, a reference symbol P4 may indicate a jog-free layout. Reference symbol P5 may indicate a result of optical proximity correction (OPC). Reference symbol P6 indicates whether a simulation result of an optical proximity correction (OPC) converges towards a skewed layout.

If an optical proximity correction (OPC) is performed using the jog-free layout P4 not including a jog, the probability that a notch and a bridge are generated may be reduced. That is, the probability that the simulation result P5 converges towards a skewed layout may increase, so that a time required decreases.

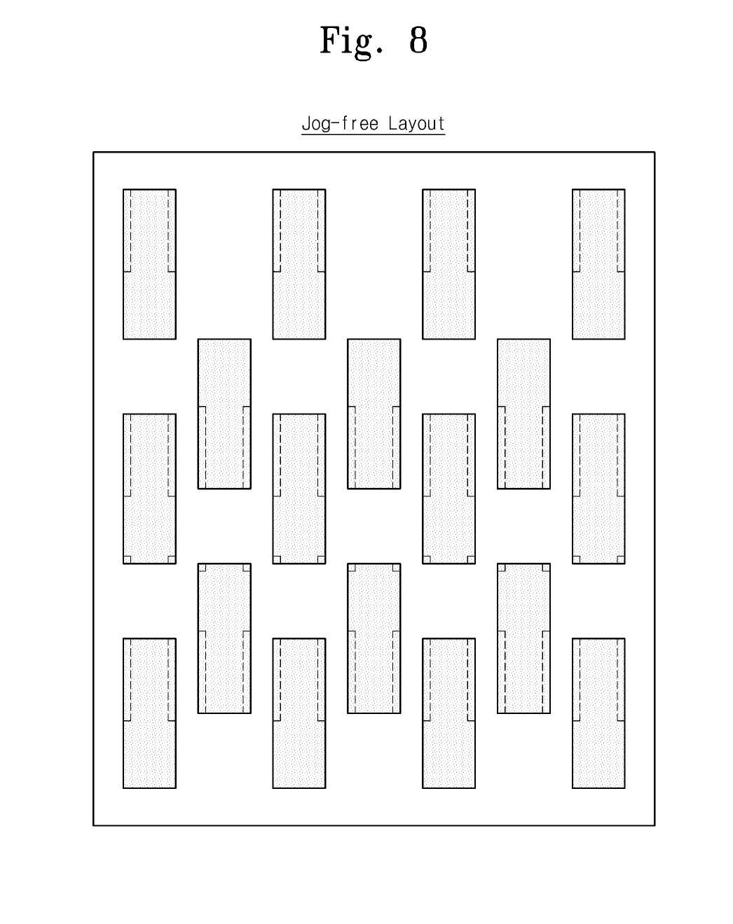

FIG. 8 is a diagram illustrating a jog-free layout produced according to an envelope of a skewed layout of FIG. 3. Here, a jog-free layout may not have a jog. Thus, fragmentation and optical proximity correction (OPC) may be efficiently performed.

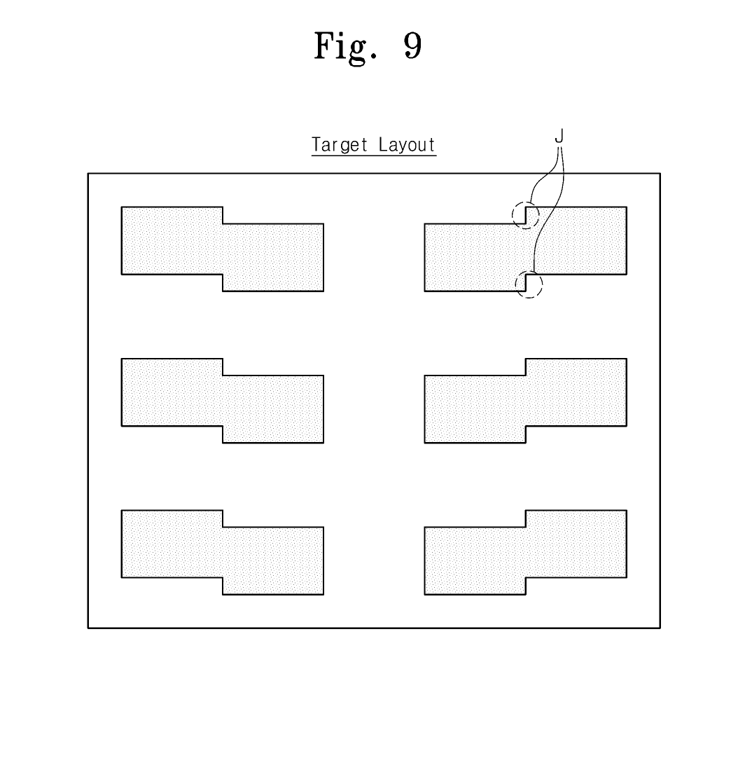

FIG. 9 is a diagram illustrating a target layout according to another embodiment of the inventive concept. Referring to FIG. 9, a target layout may include jogs J. The target layout may be used to form holes or the like at a semiconductor device, for example, holes having diagonal shapes.

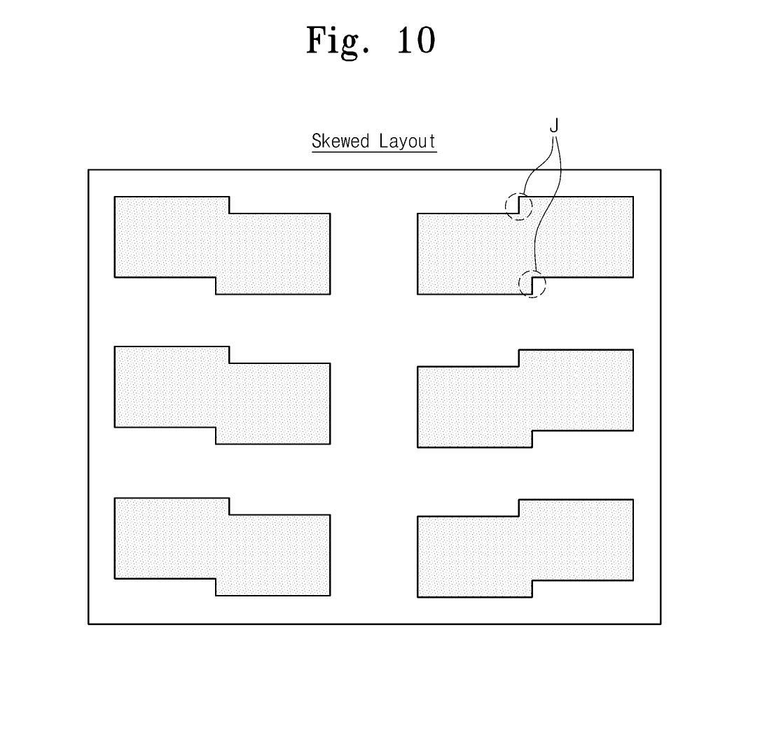

FIG. 10 is a diagram illustrating a skewed layout obtained by retargeting a target layout of FIG. 9. Referring to FIGS. 9 and 10, a skewed layout may be produced in view of an etching skew. A skewed layout may include jogs J.

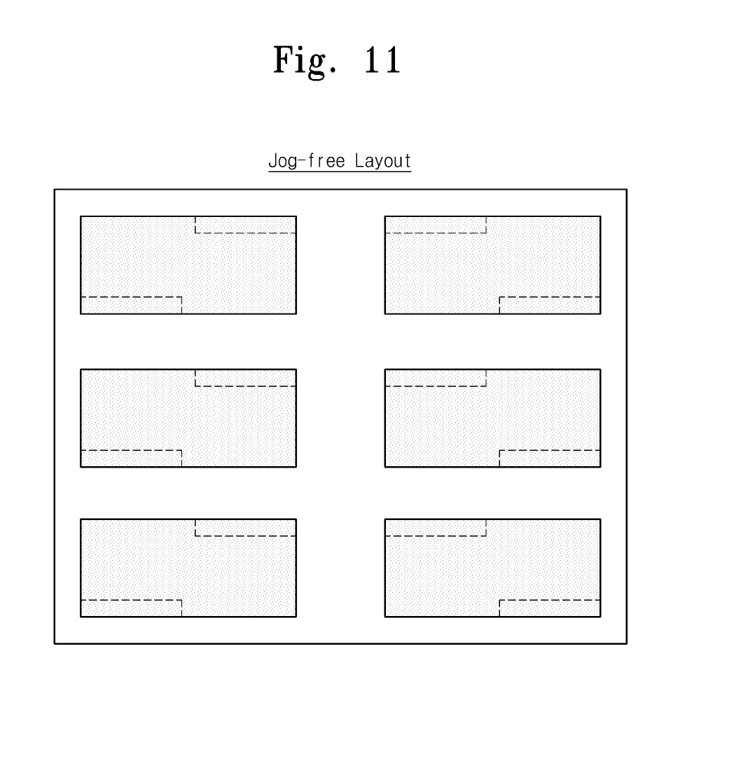

FIG. 11 is a diagram illustrating a jog-free layout produced according to an envelope of a skewed layout of FIG. 10. Referring to FIGS. 10 and 11, a jog-free layout may be produced based on an envelope of a skewed layout which does not include jogs and includes a skewed layout. The jog-free layout may include a skewed layout, and may include a minimum area quadrangle that excludes jogs J.

The jog-free layout may be fragmented, and an optical proximity correction (OPC) may be performed. The optical proximity correction may be iteratively performed until a layout is acquired where a simulation result converges towards a skewed layout, for example, shown at FIG. 9). That is, the optical proximity correction may be repeated until is acquired diagonal pattern including jogs such as the jogs J of the skewed layout of FIG. 9. If patterning is performed according to the acquired layout, diagonal patterns may be formed including jogs J as shown in the target layout of FIG. 9.

According to an embodiment of the inventive concept, although a jog-free layout is used to improve accurate level and speed of the optical proximity correction, there may be produced a variety of patterns including jogs J.

A length of each edge of a target layout including jogs J may be adjusted variously according to a design rule of a semiconductor device. In the case of a conventional optical proximity correction, a specialized optical proximity correction may be required whenever a target layout is changed. According to an embodiment of the inventive concept, since optical proximity correction (OPC) is performed according to a jog-free layout, there may be provided a recipe of optical proximity correction (OPC) capable of being applied to various skewed layouts in the same manner.

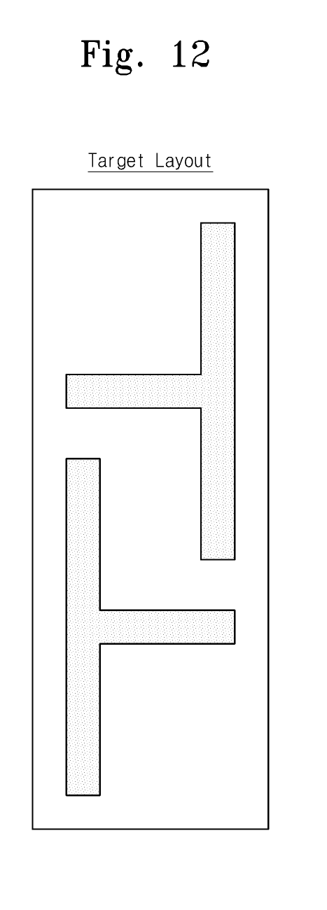

FIG. 12 is a diagram illustrating a target layout according to another embodiment of the inventive concept. Referring to FIG. 12, a target layout may have a line type, although other types of target layouts can equally apply.

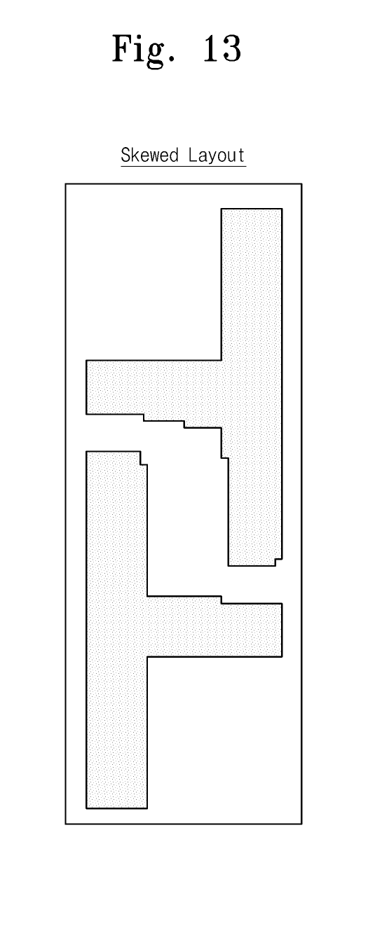

FIG. 13 is a diagram illustrating a skewed layout obtained by retargeting a target layout of FIG. 12. Referring to FIGS. 12 and 13, a skewed layout may be formed in view of an etching skew. The skewed layout may include jogs.

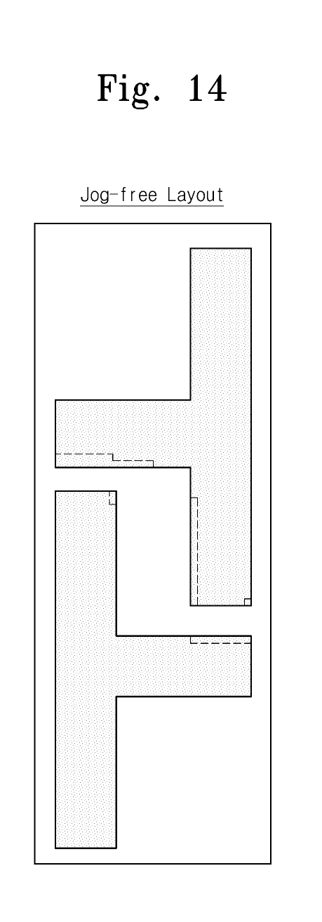

FIG. 14 is a diagram illustrating a jog-free layout produced using an envelope of a skewed layout of FIG. 13. Referring to FIGS. 13 and 14, a jog-free layout may be produced based on an envelope of a skewed layout which includes a skewed layout excluding jogs. The jog-free layout may include a skewed layout, and may be a minimum area polygon excluding jogs.

An optical proximity correction (OPC) may be performed based on the jog-free layout. Materials used to form a semiconductor device may be patterned based on a layout acquired through the optical proximity correction (OPC).

According to an embodiment of the inventive concept, optical proximity correction (OPC) based on a jog-free layout may be applied to lines as well as holes of a semiconductor device. With the optical proximity correction (OPC) based on a jog-free layout, the optical proximity correction (OPC) may be performed in the same manner, regardless of a shape of a target layout and a shape of a skewed layout. Thus, an accurate level of patterning of a semiconductor device may be improved, and a time required may be shortened.

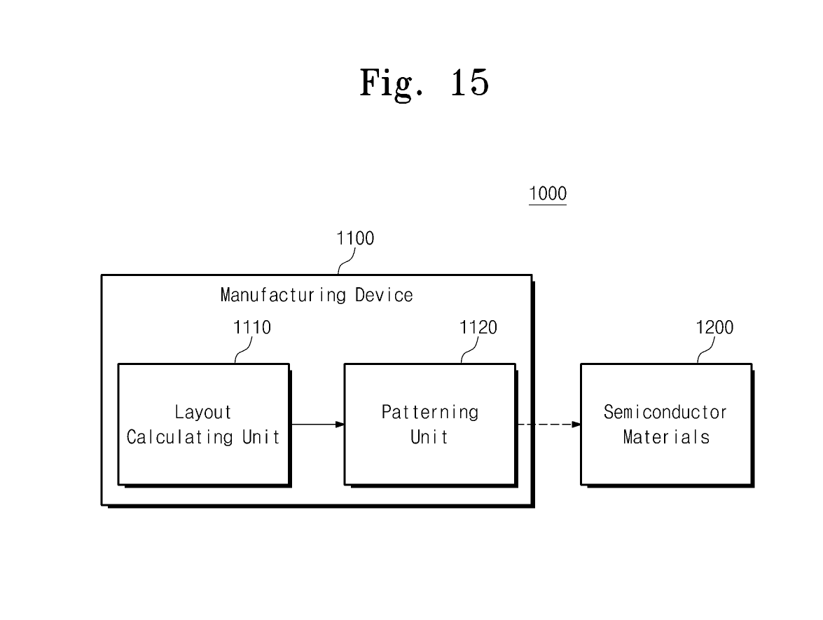

FIG. 15 is a block diagram schematically illustrating a semiconductor device manufacturing system according to an embodiment of the inventive concept. Referring to FIG. 15, a semiconductor device manufacturing system 1000 may include a manufacturing device 1100 and semiconductor materials 1200.

The manufacturing device 1100 may include a layout calculating unit 1110 and a patterning unit 1120. The layout calculating unit 1110, as described with reference to FIG. 1, may perform optical proximity correction (OPC) in accordance with some embodiments, for example, those described herein, by generating a skewed layout based on a target layout, generating a jog-free layout based on the skewed layout, and fragmenting the jog-free layout. A layout acquired through the optical proximity correction (OPC) may be transferred to the patterning unit 1120.

The patterning unit 1120 may pattern the semiconductor materials 1200 based on a layout transferred from the layout calculating unit 1110. The patterning unit 1120 may pattern the semiconductor materials 1200 to generate various elements such as holes, lines, and so on.

The semiconductor materials 1200 may be patterned by the patterning unit 1120 to form a semiconductor device. For example, the semiconductor materials 1200 may be patterned to form processors such as a CPU, an application processor, a modem, a memory controller, an encoder/decoder, and so on. The semiconductor materials 1200 may be patterned to form memories such as SRAM, DRAM, MRAM, PRAM, FeRAM, RRAM, flash memory, and so on.

With the inventive concept, a target layout may be changed into a skewed layout which reflects process skew and OPC prediction error, the skewed layout may be changed into a jog-free layout, and optical proximity correction (OPC) may be performed by fragmenting the jog-free layout. Since fragmentation and optical proximity correction are performed using a layout that excludes jogs, a semiconductor device manufacturing method may be simple, and an accurate level thereof may be improved.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A method of manufacturing a semiconductor device comprising:
forming a target layout;
producing a skewed layout that includes retargeting the target layout;
detecting an envelope of the skewed layout;
generating a jog-free layout according to the detected envelope;
fragmenting the jog-free layout;
acquiring a layout that converges towards the skewed layout by performing an optical proximity correction on the fragmented jog-free layout; and
patterning a material for forming the semiconductor device using the acquired layout.

2. The method of claim 1, wherein the envelope is a polygon which includes the skewed layout and excludes jogs.

3. The method of claim 2, wherein the jog comprises a surface having a length less than a reference value.

4. The method of claim 3, wherein the reference value is determined according to a design rule of the semiconductor device.

5. The method of claim 1, wherein the envelope is a quadrangle including the skewed layout.

6. The method of claim 1, wherein acquiring the layout converging towards the skewed layout comprises:
performing an iterative operation, in which fragments of the fragmented jog-free layout are independently adjusted and a patterning simulation is performed using the adjusted fragmented jog-free layout until a simulation result converging towards the skewed layout is acquired.

7. The method of claim 1, wherein patterning the material for forming the semiconductor device using the acquired layout comprises:
patterning holes to form the semiconductor device.

8. The method of claim 1, wherein patterning the material for forming the semiconductor device using the acquired layout comprises:
patterning lines to form the semiconductor device.

9. The method of claim 1, wherein the target layout has at least one jog.

10. A semiconductor device manufacturing device comprising:
a layout calculating unit that generates a final layout according to a target layout; and
a patterning unit that patterns semiconductor materials according to the final layout transferred from the layout calculating unit,
wherein the layout calculating unit generates the final layout by producing a skewed layout from the target layout in view of a skew, generates a jog-free layout based on an envelope of the skewed layout, and fragments the jog-free layout for performing an optical proximity correction.

11. The semiconductor device of claim 10, wherein the patterning unit patterns holes to form a semiconductor device from the semiconductor material.

12. The semiconductor device of claim 10, wherein the patterning unit patterns lines to form a semiconductor device from the semiconductor material.

13. The semiconductor device of claim 10, wherein the layout calculating unit performs an iterative operation, in which the fragments are independently adjusted and a patterning simulation is performed using the adjusted fragmented jog-free layout until a simulation result converging towards the skewed layout is acquired.

14. A method of manufacturing a semiconductor device comprising:
generating a final layout according to a target layout, comprising:
producing a skewed layout from the target layout in view of a skew;
generating a jog-free layout based on an envelope of the skewed layout;
fragmenting the jog-free layout; and
performing an optical proximity correction on the fragmented jog-free layout; and
patterning semiconductor materials according to the final layout.

15. The method of claim 14, wherein the envelope is a polygon which includes the skewed layout and excludes jogs.

16. The method of claim 14, wherein the envelope is a quadrangle including the skewed layout.

17. The method of claim 14, further comprising:
acquiring a layout that converges towards the skewed layout by performing the optical proximity correction on the fragmented jog-free layout.

18. The method of claim 17, wherein acquiring the layout converging towards the skewed layout comprises:
performing an iterative operation, in which fragments of the fragmented jog-free layout are independently adjusted and a patterning simulation is performed using the adjusted fragmented jog-free layout until a simulation result converging towards the skewed layout is acquired.

19. The method of claim 1, wherein patterning the semiconductor materials comprises patterning holes to form the semiconductor device.

20. The method of claim 1, wherein patterning the semiconductor materials comprises patterning lines to form the semiconductor device.
